(19) United States
(12) Patent Application Publication
(10) Pub. No.: US 2017/0144368 A1
(43) Pub. Date: May 25, 2017

(54) PROCESS FOR ADDITIVE MANUFACTURING USING THERMOPLASTIC MATERIALS HAVING SELECTED MELT INDEXES

(71) Applicant: SABIC Global Technologies B.V., Bergen op Zoom (NL)

(72) Inventors: Malvika Bihari, Evansville, IN (US); Satish Kumar Gaggar, Hoover, AL (US); Keith E. Cox, Newburgh, IN (US); Thomas Hocker, Pittsfield, MA (US)

(21) Appl. No.: 15/317,280

(22) PCT Filed: Jun. 15, 2015
(86) PCT No.: PCT/US2015/035773

§ 371 Date: Dec. 8, 2016

Related U.S. Application Data
(60) Provisional application No. 62/012,610, filed on Jun. 16, 2014.

(51) Int. Cl. B29C 67/00; B33Y 70/00; B33Y 80/00; B33Y 10/00

(52) U.S. Cl. CPC B29C 67/0055; B33Y 10/00; B33Y 70/00; B33Y 80/00; B29K 2105/0067

(57) ABSTRACT

Disclosed herein is a method of making, and articles made from, a thermoplastic article comprising: depositing a plurality of layers of thermoplastic material in a preset pattern and fusing the plurality of layers of material to form the article wherein the thermoplastic material comprise a thermoplastic composition having a melt flow index of 30 grams/10 minutes to 75 grams/10 minutes when measured according to ASTM D1238-04 at 230° C. and 3.8 kilograms or a melt flow index of 30 grams/10 minutes to 75 grams/10 minutes when measured according to ASTM D1238-04 at 300° C. and 1.2 kilograms.

### BACKGROUND

Material extrusion is a type of additive manufacturing (AM) process for the manufacture of three-dimensional objects by formation of multiple fused layers.

Material extrusion can be used to make final production parts, fixtures and molds as well as to make prototype models for a wide variety of products. However, the strength of the parts in the build direction is limited by the bond strength and effective bonding surface area between subsequent layers of the build. These two build properties can diminish the adhesion between layers in two ways. In some embodiments, each layer is a separate melt stream. In some instances, the polymer chains of a new layer may not easily comingle with those of the antecedent (or previous) layer. Secondly, because in some instances the previous layer has already cooled, the inherent cohesive properties of the material for bonding or fusing may be insufficient when relying on the conduction of heat from the new layer alone. Moreover, the reduced adhesion between layers also results in a highly stratified surface finish.

Accordingly, a need exists for a material extrusion process capable of producing parts with improved aesthetic qualities and structural properties.

### SUMMARY

The above-described and other deficiencies of the art are met by a method of making an article comprising: depositing a plurality of layers of thermoplastic material in a preset pattern and fusing the plurality of layers of thermoplastic material to form the article wherein the thermoplastic material comprises a thermoplastic composition having a melt flow index of 30 grams/10 minutes to 75 grams/10 minutes when measured according to ASTM D1238-04 at either 230° C. and 3.8 kilograms or at 300° C. and 1.2 kilograms.

In another embodiment, an article is made a material extrusion additive manufacturing technique using a thermoplastic material having a melt flow index of 30 grams/10 minutes to 75 grams/10 minutes when measured according to ASTM D1238-04 at either 230° C. and 3.8 kilograms or at 300° C. and 1.2 kilograms, said article a shear strength of 16 megapascals (MPa) to 25 megapascals (MPa).

In one specific embodiment, a method of making a thermoplastic article comprises depositing a plurality of layers of thermoplastic material in a preset pattern and fusing the plurality of layers of material to form the article wherein the thermoplastic material comprises at least one polycarbonate homopolymer having a combined weight average molecular weight of 15,000 to 25,000 as determined by gel permeation chromatography (GPC) using polycarbonate standards and having a melt flow index of 30 grams/10 minutes to 75 grams/10 minutes when measured according to ASTM D1238-04 at 300° C. and 1.2 kilograms.

In another specific embodiment, a method of making a thermoplastic article comprises depositing a plurality of layers of thermoplastic material in a preset pattern and fusing the plurality of layers of material to form the article wherein the thermoplastic material comprises a thermoplastic composition comprising an acrylonitrile butadiene styrene copolymer having a poly(styrene acrylonitrile) weight average molecular weight of 60,000 to 97,000 as determined by GPC using polystyrene standards and a rubber content of 15 to 30 weight percent (wt %) based on the total weight of the acrylonitrile butadiene styrene copolymer and having a melt flow index of 30 grams/10 minutes to 75 grams/10 minutes when measured according to ASTM D1238-04 at 230° C. and 3.8 kilograms.

In another specific embodiment, a method of making a thermoplastic article comprises depositing a plurality of layers of thermoplastic material in a preset pattern and fusing the plurality of layers of material to form the article wherein the thermoplastic material comprises at least one polycarbonate copolymer having aromatic structural units in combination with aliphatic structural units having a combined weight average molecular weight of 10,000 to 24,000 as determined by GPC using polycarbonate standards and having a melt flow index of 30 grams/10 minutes to 75 grams/10 minutes when measured according to ASTM D1238-04 at 300° C. and 1.2 kilograms. The thermoplastic composition may further comprise a polycarbonate homopolymer.

In another embodiment, a method of making a thermoplastic article comprises depositing a plurality of layers of thermoplastic material in a preset pattern and fusing the plurality of layers of material to form the article wherein the thermoplastic material comprises a thermoplastic composition comprising at least one polycarbonate copolymer having aromatic structural units in combination with siloxane structural units having a combined weight average molecular weight of 15,000 to 35,000 as determined by GPC using polycarbonate standards and having a melt flow index of 30 grams/10 minutes to 75 grams/10 minutes when measured according to ASTM D1238-04 at 300° C. and 1.2 kilograms. The thermoplastic composition may further comprise a polycarbonate homopolymer.

In another specific embodiment, a method of making a thermoplastic article comprises depositing a plurality of layers of thermoplastic extruded material in a preset pattern and fusing the plurality of layers of extruded material to form the article wherein the thermoplastic extruded material comprises a thermoplastic composition comprising at least one poly(aliphatic ester-carbonate) having a combined weight average molecular weight of 10,000 to 24,000 as determined by GPC using polycarbonate standards and having a melt flow index of 30 grams/10 minutes to 75 grams/10 minutes when measured according to ASTM D1238-04 at 300° C. and 1.2 kilograms. The thermoplastic composition may further comprise a polycarbonate homopolymer.

In another specific embodiment, a method of making a thermoplastic article comprises depositing a plurality of layers of thermoplastic material in a preset pattern and fusing the plurality of layers of material to form the article wherein the thermoplastic material comprises a thermoplastic composition comprising at least one poly(siloxane-carbonate) having a combined weight average molecular weight of 15,000 to 35,000 as determined by GPC using polycarbonate standards and having a melt flow index of 30 grams/10 minutes to 75 grams/10 minutes when measured according to ASTM D1238-04 at 300° C. and 1.2 kilograms. The thermoplastic composition may further comprise a polycarbonate homopolymer having a weight average molecular weight of 10,000 to 20,000 as determined by GPC using polycarbonate standards.

Also described herein are the articles produced by the methods described above.

The above described and other features are exemplified by the following detailed description, examples, and claims.

### DETAILED DESCRIPTION

Disclosed herein are material extrusion methods capable of producing parts with increased bonding between adjacent layers. Without being bound by theory, it is believed that the favorable results obtained herein, e.g., high strength three dimensional thermoplastic polymeric components, can be achieved through choosing the melt flow index alone, or optionally with the molecular weight of the thermoplastic polymeric material. The melt flow alone or optionally with molecular weight allows the thermoplastic material to remain in a fluid state for a longer time thereby helping to relieve internal stresses and resulting in better adhesion between layers of extruded material. By appropriately choosing the melt flow and molecular weight, the subsequently deposited material has the necessary physical characteristics to adhere to the previously deposited material, thus increasing adhesion in all directions. In addition, an increased bonding between layers can overcome some surface tension between layers resulting in cohesion which can enable improved surface quality of parts. Accordingly, parts with superior mechanical and aesthetic properties can be manufactured.

In some embodiments of the methods, a plurality of layers is formed in a preset pattern by an additive manufacturing process. “Plurality” as used in the context of additive manufacturing includes 20 or more layers. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed.

As used herein, “layer” is a term of convenience that includes any shape, regular or irregular, having at least a predetermined thickness. In some embodiments, the size and configuration two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments the thickness of each layer as formed is 0.5 millimeters (mm) to 5 mm.

The preset pattern can be determined from a three-dimensional digital representation of the desired article as is known in the art and described in further detail below.

The term material extrusion as used herein involves depositing or building a part or article layer-by-layer. In some embodiments, this can occur by heating thermoplastic material to a semi-liquid state and extruding it through a nozzle or orifice according to digitally computer-controlled paths so that the adjacent layers will fuse together through their internal heats of conduction or through added heat from another source, or another chemical or physical fusing means or combinations thereof. After the material is extruded, it is then deposited as a sequence of layers on a substrate in an x-y plane. The extruded modeling material fuses to previously deposited modeling material, and solidifies upon a drop in temperature. The position of the extrusion head relative to the substrate is then moved along a z-axis (perpendicular to the x-y plane), and the process is then repeated to form a 3D model resembling the digital representation. In alternative embodiments, an extruded string of pellets or filament can be prepared, and allowed to cool in coil form, and then the coil later deposited using the same type of digital modelling described above to form layers therefrom. For example, the extruded material article can be made by laying down a plastic filament or string of pellets that is unwound from a coil or is deposited from an extrusion head. These deposited layers are fused together using heat from an external source or another chemical or physical fusing means, or combinations thereof. Material extrusion can utilize a modeling material with or without a support material. The modeling material includes the finished piece, and the support material includes scaffolding that can be mechanically removed, washed away or dissolved when the process is complete.

The term material extrusion additive manufacturing technique as used in the specification and claims means that the article of manufacture can be made by a material extrusion process as described above. These material extrusion additive manufacturing techniques include fused deposition modeling and fused filament fabrication as well as other material extrusion technologies as defined by ASTM F2792-12a.

Any other additive manufacturing process can be used herein, provided that the process allows the depositing of at least one layer of a thermoplastic material upon another layer of thermoplastic and fusing those two layers together and repeating these operations until a build or article is made

Systems for material extrusion are known. An exemplary material extrusion additive manufacturing system includes a build chamber and a supply source for the thermoplastic material. The build chamber includes a build platform, a gantry, and a dispenser for dispensing the thermoplastic material, for example an extrusion head. The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other. Alternatively the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions.

The above material extrusion techniques include techniques such as fused deposition modeling and fused filament fabrication as well as others as described in ASTM F2792-12a. In fused material extrusion techniques, an article can be produced by heating a thermoplastic material to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted thermoplastic material fuses to the previously deposited layer, and solidifies upon a drop in temperature. Extrusion of multiple subsequent layers builds the desired shape. In some embodiments at least one layer of an article is formed by melt deposition, and in other embodiments, more than 10, or more than 20, or more than 50 of the layers of an article are formed by melt deposition, up to and including all of the layers of an article being formed by melt deposition.

The extruded material employed herein is made from a thermoplastic composition. For example, the thermoplastic composition can comprise polycarbonate homopolymer, polycarbonate copolymer, elastomer-modified graft copolymer, polyester, polyphenylene ether, polystyrene, polyacrylate, and combinations thereof. Exemplary polycarbonate copolymers include poly (aliphatic ester-carbonate) and poly(siloxane-carbonate). Exemplary elastomer-modified graft copolymers include acrylonitrile butadiene styrene (ABS).

“Polycarbonate” as used herein means a polymer or copolymer having repeating structural carbonate units of formula (1)

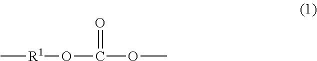

wherein at least 60 percent of the total number of R¹ groups is aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

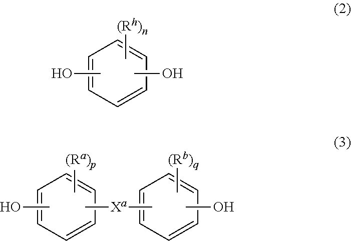

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of specific dihydroxy compounds include bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”, in which in which each of A¹ and A² is p-phenylene and Y¹ is isopropylidene in formula (3)), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane (DMBPC), and from bisphenol A and 1,1-bis(4-hydroxy-3-methylphenyl)-3,3,5-trimethylcyclohexane (isophorone bisphenol).

Polycarbonate copolymers include copolymers comprising carbonate units and ester units (“poly(ester-carbonate)s”, also known as polyester-polycarbonates). Poly(ester-carbonate)s further contain, in addition to recurring carbonate chain units of formula (1), repeating ester units of formula (4)

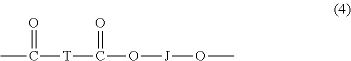

wherein J is a divalent group derived from a dihydroxy compound (which includes a reactive derivative thereof), and can be, for example, a C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₂₋₂₀ alkylene, a C₆₋₂₀ cycloalkylene, or a C₆₋₂₀ arylene. Copolyesters containing a combination of different T and/or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-propylene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85.

In an embodiment, the polycarbonate comprises at least one (preferably 1 to 5) linear homopolymer containing bisphenol A carbonate units. A linear polymer is defined as a polymer made without the intentional addition of branching agents. The linear homopolymer can have a combined weight average molecular weight of 10,000 to 40,000 g/mol as determined by GPC using polycarbonate standards. “Polycarbonate standards” and “polystyrene standards”, as used herein, refer to weight standards used to establish the GPC calibration curve. Within this range the combined weight average molecular weight can be greater than or equal to 15,000 or greater than or equal to 17,000. Also within this range the combined weight average molecular weight can be less than or equal to 35,000. The phrase “combined weight average molecular weight” as used herein means the average of all of the weight average molecular weights of these polymeric will be within the prescribed ranges. For example, if 3 homopolymers having 10,000, 20,000 and 30,000 weight average molecular weights, respectively, were combined and the prescribed range was of 15,000 to 25,000 weight average molecular weight, the combined weight average molecular weight in this case would be 20,000 (60,000 divided by 3) and would be within thais prescribed range.

The linear polycarbonate homopolymer can have a melt flow index of 30 grams/10 minutes to 75 grams/10 minutes, when measured according to ASTM D1238-04 at 300° C. and 1.2 kilograms. Within this range the melt flow index, some embodiments can have a melt flow index of 33 grams/10 minutes to 60 grams/10 minutes. Other embodiments can have a melt flow index of 35 grams/10 minutes to 50 grams/10 minutes.

In an embodiment the polycarbonate comprises at least one (preferably 1 to 5) branched, end-capped bisphenol A polycarbonate produced via interfacial polymerization, containing up to 5 mol % branching agent. In an embodiment, the branched, end-capped bisphenol A polycarbonate is produced via interfacial polymerization containing 0.1 to 5 mol % 1,1,1-tris(4-hydroxyphenyl)ethane (THPE) branching agent. The branched, end-capped bisphenol A polycarbonate has a combined weight average molecular weight of 20,000 to 50,000 as determined by GPC using polycarbonate standards. Within this range the combined weight average molecular weight can be greater than or equal to 25,000. Also within this range the combined weight average molecular weight can be less than or equal to 35,000.

A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer), a copolymer comprising bisphenol A carbonate units and 1,1-bis(4-hydroxy-3-methylphenyl)cyclohexane carbonate units (a BPA-DMBPC copolymer), a copolymer comprising bisphenol A carbonate units and isosorbide carbonate units, and a copolymer comprising bisphenol A carbonate units and isophorone bisphenol carbonate units.

The at least one copolycarbonate of bisphenol A and bulky bisphenol carbonate units has a combined weight average molecular weight of 15,000 to 30,000 as determined by GPC using polycarbonate standards. Within this range the combined weight average molecular weight can be greater than or equal to 17,000. Also within this range the combined weight average molecular weight can be less than or equal to 25,000.

Other specific polycarbonates that can be used include poly(ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC) depending on the relative ratio of carbonate units and ester units.

A specific example of a poly (ester-carbonate) is a poly (aliphatic ester)-carbonate derived from a linear C₆₋₂₀ aliphatic dicarboxylic acid (which includes a reactive derivative thereof), specifically a linear C₆-C₁₂ aliphatic dicarboxylic acid (which includes a reactive derivative thereof). Specific dicarboxylic acids include n-hexanedioic acid (adipic acid), n-decanedioic acid (sebacic acid), and alpha, omega-C₁₂ dicarboxylic acids such as dodecanedioic acid (DDDA). A specific poly(aliphatic ester)-polycarbonate is of formula (8):

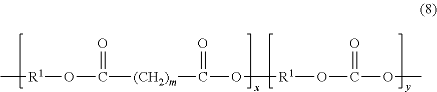

wherein each R¹ can be the same or different, and is as described in formula (1), m is 4 to 18, specifically 4 to 10, and the average molar ratio of ester units to carbonate units x:y is 99:1 to 1:99, including 13:87 to 2:98, or 9:91 to 2:98, or 8:92 to 2:98. In a specific embodiment, the poly(aliphatic ester)-polycarbonate copolymer comprises bisphenol A sebacate ester units and bisphenol A carbonate units, having, for example an average molar ratio of x:y of 2:98 to 8:92, for example 6:94.

The at least one (preferably, 1 to 5) poly(aliphatic ester-carbonate) can have a combined weight average molecular weight of 10,000 to 40,000 as determined by GPC using polycarbonate standards. Within this range the combined weight average molecular weight can be greater than or equal to 17,000. Also within this range the combined weight average molecular weight can be less than or equal to 35,000.

The poly(aliphatic ester-carbonate) can have a melt flow index of 30 grams/10 minutes to 75 grams/10 minutes, when measured according to ASTM D1238-04 at 300° C. and 1.2 kilograms. Within this range the melt flow index, some embodiments can have a melt flow index of 33 grams/10 minutes to 60 grams/10 minutes. Other embodiments can have a melt flow index of 35 grams/10 minutes to 50 grams/10 minutes.

The composition may comprise at least one (preferably, 1 to 5) poly(siloxane-carbonate) copolymer, also referred to as a poly(siloxane-carbonate). The polydiorganosiloxane (also referred to herein as “polysiloxane”) blocks comprise repeating diorganosiloxane units as in formula (10)

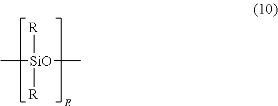

wherein each R is independently a C₁₋₁₃ monovalent organic group. For example, R can be a C₁-C₁₃ alkyl, C₁-C₁₃ alkoxy, C₂-C₁₃ alkenyl, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent poly(siloxane-carbonate) is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to 1,000, specifically 2 to 500, 2 to 200, or 2 to 125, 5 to 80, or 10 to 70. In an embodiment, E has an average value of 10 to 80 or 10 to 40, and in still another embodiment, E has an average value of 40 to 80, or 40 to 70. Where E is of a lower value, e.g., less than 40, it can be desirable to use a relatively larger amount of the polycarbonate-polysiloxane copolymer. Conversely, where E is of a higher value, e.g., greater than 40, a relatively lower amount of the polycarbonate-polysiloxane copolymer can be used.

A combination of a first and a second polycarbonate-polysiloxane copolymers can be used, wherein the average value of E of the first copolymer is less than the average value of E of the second copolymer.

In an embodiment, the polydiorganosiloxane blocks are of formula (11)

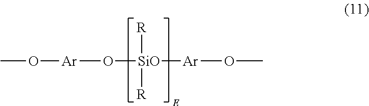

wherein E is as defined above; each R can be the same or different, and is as defined above; and Ar can be the same or different, and is a substituted or unsubstituted C₆-C₃₀ arylene, wherein the bonds are directly connected to an aromatic moiety. Ar groups in formula (11) can be derived from a C₆-C₃₀ dihydroxyarylene compound, for example a dihydroxyarylene compound of formula (3) or (6) above. dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, polydiorganosiloxane blocks are of formula (13)

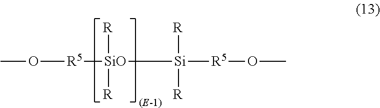

wherein R and E are as described above, and each R⁵ is independently a divalent C₁-C₃₀ organic group, and wherein the polymerized polysiloxane unit is the reaction residue of its corresponding dihydroxy compound. In a specific embodiment, the polydiorganosiloxane blocks are of formula (14):

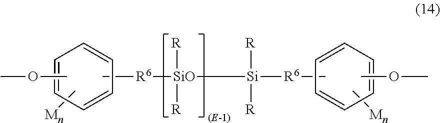

wherein R and E are as defined above. R⁶ in formula (14) is a divalent C₂-C₈ aliphatic. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In an embodiment, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, R is methyl, M is methoxy, n is one, R⁶ is a divalent C₁-C₃ aliphatic group. Specific polydiorganosiloxane blocks are of the formula

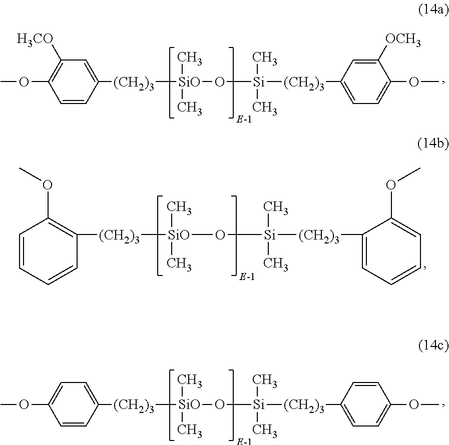

or a combination comprising at least one of the foregoing, wherein E has an average value of 2 to 200, 2 to 125, 5 to 125, 5 to 100, 5 to 50, 20 to 80, or 5 to 20.

Blocks of formula (14) can be derived from the corresponding dihydroxy polydiorganosiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(siloxane-carbonate) can then be manufactured, for example, by the synthetic procedure of European Patent Application Publication No. 0 524 731 A1 of Hoover, page 5, Preparation 2.

Transparent poly(siloxane-carbonate) comprise carbonate units (1) derived from bisphenol A, and repeating siloxane units (14a), (14b), (14c), or a combination comprising at least one of the foregoing (specifically of formula 14a), wherein E has an average value of 4 to 50, 4 to 15, specifically 5 to 15, more specifically 6 to 15, and still more specifically 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(siloxane-carbonate) copolymers.

The poly(siloxane-carbonate) can comprise 50 to 99 weight percent of carbonate units and 1 to 50 weight percent siloxane units. Within this range, the polyorganosiloxane-polycarbonate copolymer can comprise 70 to 98 weight percent, more specifically 75 to 97 weight percent of carbonate units and 2 to 30 weight percent, more specifically 3 to 25 weight percent siloxane units.

In an embodiment, the poly(siloxane-carbonate) comprises 10 wt % or less, specifically 6 wt % or less, and more specifically 4 wt % or less, of the polysiloxane based on the total weight of the poly(siloxane-carbonate) copolymer, and are generally optically transparent. In another embodiment, the poly(siloxane-carbonate) copolymer comprises 10 wt % or more, specifically 12 wt % or more, and more specifically 14 wt % or more, of the polysiloxane copolymer based on the total weight of the poly(siloxane-carbonate) copolymer, are generally optically opaque.

It is explicitly contemplated that the poly(siloxane-carbonate) includes polymers which further comprise ester units as described above.

The at least one (preferably, 1 to 5) poly(siloxane-carbonate) can have a combined weight average molecular weight of 15,000 to 35,000 as determined by GPC using polycarbonate standards. Within this range the combined weight average molecular weight can be greater than or equal to 20,000. Also within this range the combined weight average molecular weight can be less than or equal to 33,000.

Poly(siloxane-carbonate) can have a melt flow index of 30 grams/10 minutes to 75 grams/10 minutes, when measured according to ASTM D1238-04 at 300° C. and 1.2 kilograms. Within this range the melt flow index, some embodiments can have a melt flow index of 33 grams/10 minutes to 60 grams/10 minutes. Other embodiments can have a melt flow index of 35 grams/10 minutes to 50 grams/10 minutes.

In one embodiment the thermoplastic composition comprises a polycarbonate homopolymer having a weight average molecular weight of 20,000 to 25,000, and a polycarbonate homopolymer having a weight average molecular weight of 17,000 to 19,000, wherein the weight average molecular weights are determined by GPC using polycarbonate standards.

In one embodiment the thermoplastic composition comprises at least one (preferably 1 to 5) poly(aliphatic ester-carbonate) having a combined weight average molecular weight of 19,000 to 23,000. The thermoplastic composition can further comprise a at least one (preferably 1 to 5) poly(aliphatic ester-carbonate) having a combined weight average molecular weight of 33,000 to 38,000, and a homopolycarbonate having a weight average molecular weight of 15,000 to 19,000 or a combination thereof. Weight average molecular weight is determined by GPC using polycarbonate standards

In one embodiment the thermoplastic composition comprises a branched, end-capped bisphenol A homopolycarbonate having a weight average molecular weight of 25,000 to 35,000, a linear homopolycarbonate having a weight average molecular weight of 20,000 to 25,000, and a linear homopolycarbonate having a weight average molecular weight of 15,000 to 20,000. Weight average molecular weight is determined by GPC using polycarbonate standards.

In one embodiment the thermoplastic composition comprises at least one (preferably 1 to 5) poly(siloxane-carbonate) having a combined weight average molecular weight of 20,000 to 25,000, and a linear homopolycarbonate having a weight average molecular weight of 15,000 to 20,000. Weight average molecular weight is determined by GPC using polycarbonate standards.

In one embodiment the thermoplastic composition comprises a copolycarbonate of bisphenol A and bulky bisphenol carbonate units having a weight average molecular weight of 20,000 to 25,000, a linear homopolycarbonate having a weight average molecular weight of 20,000 to 25,000 and a linear homopolycarbonate having a weight average molecular weight of 25,000 to 30,000. Weight average molecular weight is determined by GPC using polycarbonate standards.

Elastomer-modified graft copolymer comprise (i) an elastomeric (i.e., rubbery) polymer substrate having a Tg less than 10° C., more specifically less than −10° C., or more specifically −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

In an embodiment, the aromatic vinyl copolymer comprises “free” styrene-acrylonitrile copolymer (SAN), i.e., styrene-acrylonitrile copolymer that is not grafted onto another polymeric chain. In a particular embodiment, the free styrene-acrylonitrile copolymer can have a weight average molecular weight of 60,000 to 97,000 Daltons as determined by GPC using polystyrene standards and can comprise various proportions of styrene to acrylonitrile. For example, free SAN can comprise 75 weight percent styrene and 25 weight percent acrylonitrile based on the total weight of the free SAN copolymer. Free SAN can optionally be present by virtue of the addition of a grafted rubber impact modifier in the composition that contains free SAN, and/or free SAN can by present independent of other impact modifiers in the composition.

The elastomer-modified graft copolymer can have a melt flow index of 30 grams/10 minutes to 75 grams/10 minutes, when measured according to ASTM D1238-04 at 300° C. and 1.2 kilograms. Within this range the melt flow index, some embodiments can have a melt flow index from 33 grams/10 minutes to 60 grams/10 minutes. Other embodiments can have a melt flow index from 35 grams/10 minutes to 50 grams/10 minutes.

The thermoplastic composition can include various additives ordinarily incorporated into polymer compositions of this type, with the proviso that the additive(s) are selected so as to not significantly adversely affect the desired properties of the thermoplastic composition, in particular the melt flow index. Such additives can be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. In general, the additives are used in the amounts generally known to be effective. For example, the total amount of the additives (other than any impact modifier, filler, or reinforcing agents) can be 0.01 to 5 wt. %, based on the total weight of the thermoplastic composition.

As described above, a plurality of thermoplastic extruded material such as pellet strings or monofilaments are deposited in a preset pattern and fused to form the article. An exemplary extrusion-based additive manufacturing system includes a build chamber and supply sources. In other embodiments the manufacturing system employs a build platform that is exposed to atmospheric conditions.

The build chamber comprises a platform, gantry, and extrusion head. The platform is a platform on which the article is built, and desirably moves along a vertical z-axis based on signals provided from a computer-operated controller. The gantry is a guide rail system that is desirably configured to move the extrusion head in a horizontal x-y plane within the build chamber based on signals provided from controller. The horizontal x-y plane is a plane defined by an x-axis and a y-axis where the x-axis, the y-axis, and the z-axis are orthogonal to each other. Alternatively the platform may be configured to move in the horizontal x-y plane and the extrusion head may be configured to move along the z-axis. Other similar arrangements may also be used such that one or both of the platform and extrusion head are moveable relative to each other.

In some embodiments, the thermoplastic composition is supplied in a melted form to the dispenser. The dispenser can be configured as an extrusion head. The extrusion head can deposit the thermoplastic composition as an extruded material strand to build the article. Examples of suitable average diameters for the extruded material strands range from about 1.27 millimeters (about 0.050 inches) to about 3.0 millimeters (about 0.120 inches). Depending on the type of thermoplastic material, the thermoplastic material can be extruded at a temperature of 200 to 450° C. In some embodiments the thermoplastic material can be extruded at a temperature of 300 to 415° C. The layers can be deposited at a build temperature (the temperature of deposition of the thermoplastic extruded material) that is 50 to 200° C. lower than the extrusion temperature. For example, the build temperature can be 15 to 250° C. In some embodiments the thermoplastic material is extruded at a temperature of 200 to 450° C., or 300 to 415° C., and the build temperature is maintained at ambient temperature.

Another embodiment is directed to an article made a material extrusion additive manufacturing technique using a thermoplastic material having a melt flow index of 30 grams/10 minutes to 75 grams/10 minutes when measured according to ASTM D1238-04 at either 230° C. and 3.8 kilograms or at 300° C. and 1.2 kilograms, said article a shear strength from 16 MPa to 25 MPA. Preferably, this article comprises at least 20 layers and is extruded at a temperature of 200° C. to 300° C. to prevent distortion caused by too high heating.

The thermoplastic compositions are further illustrated by the following non-limiting examples.

### EXAMPLES

The following examples use the materials shown in Table 1.

TABLE 1

| Material | | Description |
|---|---|---|
| | Melt Flow Index (g/10 | |
| | min @°300 C./1.2 Kg) | |
| PEC A | 40 | A thermoplastic material made from poly(aliphatic ester- |
| | | carbonate), the thermoplastic material having a weight average |
| | | molecular weight of 22,077** |
| PEC B | 25 | A thermoplastic material made from poly(aliphatic ester- |
| | | carbonate), the thermoplastic material having a weight average |
| | | molecular weight of 31,647** |
| PEC C | 7 | A thermoplastic material made from poly(aliphatic ester- |
| | | carbonate), the thermoplastic material having a weight average |
| | | molecular weight of 34,191** |
| PSC A | 35 | A thermoplastic material made from poly(siloxane-carbonate), |
| | | the thermoplastic material having a weight average molecular |
| | | weight of 20,947** |
| PSC B | 10 | A thermoplastic material made from poly(siloxane-carbonate), |
| | | the thermoplastic material having a weight average molecular |
| | | weight of 23,619** |
| PC A | 39 | A thermoplastic material made from polycarbonate |
| | | homopolymer, the thermoplastic material having a weight |
| | | average molecular weight of 21,092** |
| PC B | 7 | A thermoplastic material made from polycarbonate |
| | | homopolymer, the thermoplastic material having a weight |
| | | average molecular weight of 29,084** |
| | Melt Flow Index (g/10 | |
| | min @°230 C./3.8 Kg) | |
| ABS A | 4 | A thermoplastic material made from acrylonitrile butadiene |
| | | styrene copolymer having 22.5 weight percent butadiene rubber |
| | | and a styrene/acrylonitrile weight average molecular weight of |
| | | 100,000 |
| ABS B | 38 | A thermoplastic material made from acrylonitrile butadiene |
| | | styrene copolymer having 22.5 weight percent butadiene rubber |
| | | and a styrene/acrylonitrile weight average molecular weight of |
| | | 60,000 |
| ABS C | 0.35 | A thermoplastic material made from acrylonitrile butadiene |
| | | styrene copolymer having 30 weight percent butadiene rubber |
| | | and a styrene/acrylonitrile weight average molecular weight of |
| | | 100,000 |
| ABS D | 4.2 | A thermoplastic material made from acrylonitrile butadiene |
| | | styrene copolymer having 30 weight percent butadiene rubber |
| | | and a styrene/acrylonitrile weight average molecular weight of |
| | | 60,000 |

**calculated values

Two sample strips (76.2×127×0.8 millimeters (mm)) of the same material were stacked. An aluminum spacer (0.75 mm×2.54 mm×2.54 mm) was placed at either end of the stack. The stack was then sandwiched between two metal plates. Each metal plate was one quarter inch thick. A 3.6-4.5 kilogram (kg) weight was placed on the stack/metal plate combination to ensure good contact between the sample strips. The stack/metal plate combination with the weight was maintained at the desired temperature for the desired period of time as shown in Table 2. The stack/metal plate combination was then cooled. The two sample strips were then separated by peeling by hand. Samples that could not be separated were classified as welded. The samples that could be separated were classified based on the difficulty in separating the strips—a pair of strips that were difficult to separate were described as “heavy sticking”, a pair of strips that were somewhat difficult to separate were described as “medium sticking” and a pair of strips that were fairly easy to separate were described as “weak/light sticking”.

TABLE 2

| | Test Conditions | Results | |
|---|---|---|---|
| | | | Melt Flow Index (g/10 |
| | | | min @°230 C./3.8 Kg) |
| ABS A | 15 minutes | Medium Sticking | 4 |
| ABS B | @110° C. | Welded | 38 |
| ABS C | | Light To Medium | 0.35 |
| | | Sticking | |
| ABS D | | Medium Sticking | 4.2 |
| | | | Melt Flow Index (g/10 |
| | | | min @°300 C./1.2 Kg) |
| PEC A | 10 minutes | Welded | 40 |
| PEC B | @140° C. | Medium Sticking | 25 |
| PEC C | | Very weak sticking | 7 |
| PC A | 10 minutes | Welded | 39 |
| PC B | @ 150° C. | Very weak sticking | 7 |
| PSC A | 20 minutes | Welded | 35 |
| PSC B | @145° C. | Medium Sticking | 10 |

As shown in Table 2, thermoplastic materials with a high melt flow index and lower molecular weight showed better welding between the sample strips than comparable materials with a lower melt flow index. For example ABS A and ABS B both contain the same amount of rubber but differ in the molecular weight of the styrene-acrylonitrile portion of the material. ABS B, which has a lower molecular weight styrene acrylonitrile portion and has a higher melt flow index, has a significantly better weld strength. ABS C and D show the same results. PEC A-C, PC A & B, and PSC A & B show the same phenomenon.

Additionally, it appears that having a melt flow index of greater than or equal to 30 grams/10 minutes is useful for forming strong adhesion between the sample strips.

Filaments of materials of Table 1 were extruded with 1.75 mm target diameter. Rectangular bars of dimensions 76.2 mm×9.652 mm×6.35 mm (7×0.38×0.25 inch) were printed using the filament deposition modeling method on a Makerbot printer. The bars were printed using nozzle temperatures of 280, 300 and 320° C. Short beam shear testing (ASTM D2344/D2344M-13) was conducted on the printed bars to evaluate interfacial strength. The short beam shear strength of the samples was calculated according to the formula (0.75×peak load)/(width×thickness). Results are shown in Table 3.

TABLE 3

| | Nozzle | Shear Strength | Melt Flow |
|---|---|---|---|
| Sample | Temperature | (MPa) | (300° C./1.2 Kg) |
| PSC B | 280 | 14.8 | 10 |
| | 300 | 15.3 | |
| | 320 | 15.3 | |
| PSC A | 280 | 16.5 | 35 |
| | 300 | 17.9 | |
| | 320 | 15.8 | |
| PC B | 280 | 10.4 | 7 |
| | 300 | 14.3 | |
| | 320 | 16.1 | |
| PC A | 280 | 17.8 | 39 |
| | 300 | 17.1 | |
| | 320 | 16.7 | |
| PEC C | 280 | 11.4 | 7 |
| | 300 | 14.5 | |
| | 320 | 15.5 | |
| PEC A | 280 | 16.05 | 40 |
| | 300 | 15.8 | |
| | 320 | 15.5 | |

The higher flow materials show higher shear strength which in turn reflects higher interlayer adhesion in these materials.

It can also be seen that the high flow materials show much less variation in shear strength with nozzle temperature. Without being bound by theory it is believed that the polymer chains have sufficient mobility at low temperatures due to higher flow that allows these materials to be processed at relatively lower temperatures with good interfacial strength compared to the low flow materials. For example, samples made from PC B have lower shear strength at when the nozzle temperature is 280 and 300° C. compared to samples made from PC A made using the same nozzle temperatures. A similar trend can be seen for PEC C and PEC A.

Compositions having a melt flow of 30 to 50 g/10 minutes enable use of lower extrusion temperatures during processing thereby decreasing the energy consumption and possible degradation of the material. There is less material drooling and less material degradation when processing at lower temperatures.

The following embodiments further illustrate the invention.

### Embodiment 1

A method of making a thermoplastic article comprising: depositing a plurality of layers of thermoplastic material in a preset pattern and fusing the plurality of layers of material to form the article wherein the thermoplastic material comprises a thermoplastic composition having a melt flow index of 30 grams/10 minutes to 75 grams/10 minutes when measured according to ASTM D1238-04 at either 230° C. and 3.8 kilograms or at 300° C. and 1.2 kilograms.

### Embodiment 2

The method of Embodiment 1, wherein the thermoplastic material comprises an elastomer-modified graft copolymer which comprises (i) an elastomeric polymer substrate having a Tg less than 10° C., and (ii) a rigid polymeric superstrate grafted to the elastomeric polymer substrate having a melt flow index of 30 grams/10 minutes to 75 grams/10 minutes when measured according to ASTM D1238-04 at 230° C. and 3.8 kilograms.

### Embodiment 3

The method of Embodiment 2, wherein the elastomeric polymer substrate comprises conjugated diene rubbers, copolymers of a conjugated diene with less than 50 wt. % of a copolymerizable monomer, olefin rubbers, ethylene-vinyl acetate rubbers, silicone rubbers, elastomeric C1-8 alkyl (meth)acrylates, elastomeric copolymers of C1-8 alkyl (meth)acrylates with butadiene and/or styrene, or combinations comprising at least one of the foregoing elastomers.

### Embodiment 4

The method of any of Embodiments 1 to 3, wherein the thermoplastic material comprises styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), styrene-acrylonitrile (SAN) or a combination thereof having a melt flow index of 30 grams/10 minutes to 75 grams/10 minutes when measured according to ASTM D1238-04 at 230° C. and 3.8 kilograms.

### Embodiment 5

The method of Embodiment 1, wherein the thermoplastic material comprises an acrylonitrile butadiene styrene copolymer having a poly(styrene acrylonitrile) weight average molecular weight of 60,000 to 97,000 as determined by GPC using polystyrene standards and a rubber content of 15 to 30 wt %, based on the total weight of the acrylonitrile butadiene styrene copolymer having a melt flow index of 30 grams/10 minutes to 75 grams/10 minutes when measured according to ASTM D1238-04 at 230° C. and 3.8 kilograms.

### Embodiment 6

The method of Embodiment 1, wherein the thermoplastic material comprises at least one polycarbonate homopolymer, polycarbonate copolymer, polyester, or a combination thereof having a melt flow index of 30 grams/10 minutes to 75 grams/10 minutes when measured according to ASTM D1238-04 at 300° C. and 1.2 kilograms.

### Embodiment 7

The method of Embodiment 6, wherein the thermoplastic material comprises a linear polycarbonate homopolymer containing bisphenol A carbonate units having a melt flow index from 30 grams/10 minutes to 75 grams/10 minutes when measured according to ASTM D1238-04 at 300° C. and 1.2 kilograms.

### Embodiment 8

The method of Embodiment 6 wherein the thermoplastic material comprises a branched, end-capped bisphenol A homopolycarbonate produced via interfacial polymerization containing 0.1 to 5 mol % mol % 1,1,1-tris(4-hydroxyphenyl)ethane (THPE) branching agent.

### Embodiment 9

The method of any of Embodiments 6 to 8, wherein the thermoplastic material comprises copolycarbonate of bisphenol A and bulky bisphenol carbonate units having a melt flow index of 30 grams/10 minutes to 75 grams/10 minutes when measured according to ASTM D1238-04 at 300° C. and 1.2 kilograms.

### Embodiment 10

The method of Embodiment 9, wherein the copolycarbonate comprises bisphenol A carbonate units and 2-phenyl-3,3′-bis(4-hydroxyphenyl) phthalimidine carbonate units (a BPA-PPPBP copolymer).

### Embodiment 11

The method of Embodiment 9, wherein the copolycarbonate comprises bisphenol A carbonate units and 1,1-bis(4-hydroxy-3-methylphenyl)cyclohexane carbonate units (a BPA-DMBPC copolymer).

### Embodiment 12

The method of Embodiment 9, wherein the copolycarbonate comprises bisphenol A carbonate units and isophorone bisphenol carbonate units.

### Embodiment 13

The method of Embodiment 6, wherein the thermoplastic material comprises poly(ester-carbonate) comprising bisphenol A carbonate units and isophthalate-terephthalate-bisphenol A ester units having a melt flow index of 30 grams/10 minutes to 75 grams/10 minutes when measured according to ASTM D1238-04 at 300° C. and 1.2 kilograms.

### Embodiment 14

The method of Embodiment 13, wherein the poly(ester-carbonate) is a poly(aliphatic ester)-carbonate derived from a linear C6-20 aliphatic dicarboxylic acid.

### Embodiment 15

The method of Embodiment 14, wherein the poly(aliphatic ester)-carbonate comprises bisphenol A sebacate ester units and bisphenol A carbonate units and has a weight average molecular weight of 10,000 to 40,000 as determined by GPC using polycarbonate standards.

### Embodiment 16

The method of Embodiment 6, wherein the thermoplastic material comprises a poly(siloxane-carbonate) copolymer having a melt flow index of 30 grams/10 minutes to 75 grams/10 minutes when measured according to ASTM D1238-04 at 300° C. and 1.2 kilograms.

### Embodiment 17

The method of Embodiment 16, wherein the poly(siloxane-carbonate) copolymer comprises 50 to 99 weight percent of carbonate units and 1 to 50 weight percent siloxane units and has a weight average molecular weight of 15,000 to 35,000 as determined by GPC using polycarbonate standards.

### Embodiment 18

The method of any of Embodiments 1 to 17, wherein the thermoplastic composition has a melt flow index of 33 grams/10 minutes to 60 grams/10 minutes when measured according to ASTM D1238-04 at either 230° C. and 3.8 kilograms or at 300° C. and 1.2 kilograms.

### Embodiment 19

An article made a material extrusion additive manufacturing technique using a at least one polycarbonate homopolymer, polycarbonate copolymer, polyester, or a combination thereof, having a melt flow index of 30 grams/10 minutes to 75 grams/10 minutes when measured according to ASTM D1238-04 at 300° C. and 1.2 kilograms, said article a shear strength of 16 MPa to 25 MPa.

### Embodiment 20

The article of Embodiment 19 wherein the article comprises at least 20 layers and is extruded at a temperature from 200° C. to 300° C.

### Embodiment 21

The method of any of Embodiments 1 to 17, wherein the thermoplastic composition has a melt flow index of 35 grams/10 minutes to 50 grams/10 minutes when measured according to ASTM D1238-04 at either 230° C. and 3.8 kilograms or at 300° C. and 1.2 kilograms.

### Embodiment 22

The method of any of Embodiments 1 to 17, wherein the thermoplastic composition has a melt flow index of 35 grams/10 minutes to 45 grams/10 minutes when measured according to ASTM D1238-04 at either 230° C. and 3.8 kilograms or at 300° C. and 1.2 kilograms.

The singular forms “a,” “an,” and “the” include plural referents unless the context clearly dictates otherwise. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. The suffix “(s)” is intended to include both the singular and the plural of the term that it modifies, thereby including at least one of that term (e.g., the colorant(s) includes at least one colorants). Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of making a thermoplastic article comprising:
depositing a plurality of layers of thermoplastic material in a preset pattern and fusing the plurality of layers of material to form the article wherein the thermoplastic material comprises a thermoplastic composition having a melt flow index of 30 grams/10 minutes to 75 grams/10 minutes when measured according to ASTM D1238-04 at either 230° C. and 3.8 kilograms or at 300° C. and 1.2 kilograms.

2. The method of claim 1, wherein the thermoplastic material comprises an elastomer-modified graft copolymer which comprises (i) an elastomeric polymer substrate having a Tg less than 10° C., and (ii) a rigid polymeric superstrate grafted to the elastomeric polymer substrate having a melt flow index of 30 grams/10 minutes to 75 grams/10 minutes when measured according to ASTM D1238-04 at 230° C. and 3.8 kilograms.

3. The method of claim 2, wherein the elastomeric polymer substrate comprises conjugated diene rubbers, copolymers of a conjugated diene with less than 50 wt. % of a copolymerizable monomer, olefin rubbers, ethylene-vinyl acetate rubbers, silicone rubbers, elastomeric C1-8 alkyl (meth)acrylates, elastomeric copolymers of C1-8 alkyl (meth)acrylates with butadiene and/or styrene, or combinations comprising at least one of the foregoing elastomers.

4. The method of claim 1, wherein the thermoplastic material comprises styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), styrene-acrylonitrile (SAN) or a combination thereof having a melt flow index of 30 grams/10 minutes to 75 grams/10 minutes when measured according to ASTM D1238-04 at 230° C. and 3.8 kilograms.

5. The method of claim 1, wherein the thermoplastic material comprises an acrylonitrile butadiene styrene copolymer having a poly(styrene acrylonitrile) weight average molecular weight of 60,000 to 97,000 as determined by GPC using polystyrene standards and a rubber content of 15 to 30 wt %, based on the total weight of the acrylonitrile butadiene styrene copolymer having a melt flow index of 30 grams/10 minutes to 75 grams/10 minutes when measured according to ASTM D1238-04 at 230° C. and 3.8 kilograms.

6. The method of claim 1, wherein the thermoplastic material comprises polycarbonate homopolymer, polycarbonate copolymer, polyester, or a combination thereof having a melt flow index of 30 grams/10 minutes to 75 grams/10 minutes when measured according to ASTM D1238-04 at 300° C. and 1.2 kilograms.

7. The method of claim 6, wherein the thermoplastic material comprises a linear polycarbonate homopolymer containing bisphenol A carbonate units having a melt flow index of 30 grams/10 minutes to 75 grams/10 minutes when measured according to ASTM D1238-04 at 300° C. and 1.2 kilograms.

8. The method of claim 6 wherein the thermoplastic material comprises a branched, end-capped bisphenol A homopolycarbonate produced via interfacial polymerization containing 0.1 to 5 mol % 1,1,1-tris(4-hydroxyphenyl)ethane (THPE) branching agent.

9. The method of claim 6, wherein the thermoplastic material comprises copolycarbonate of bisphenol A and bulky bisphenol carbonate units having a melt flow index of 30 grams/10 minutes to 75 grams/10 minutes when measured according to ASTM D1238-04 at 300° C. and 1.2 kilograms.

10. The method of claim 9, wherein the copolycarbonate comprises bisphenol A carbonate units and 2-phenyl-3,3′-bis(4-hydroxyphenyl) phthalimidine carbonate units (a BPA-PPPBP copolymer).

11. The method of claim 9, wherein the copolycarbonate comprises bisphenol A carbonate units and 1,1-bis(4-hydroxy-3-methylphenyl)cyclohexane carbonate units (a BPA-DMBPC copolymer).

12. The method of claim 9, wherein the copolycarbonate comprises bisphenol A carbonate units and isophorone bisphenol carbonate units.

13. The method of claim 6, wherein the thermoplastic material comprises poly(ester-carbonate) comprising bisphenol A carbonate units and isophthalate-terephthalate-bisphenol A ester units having a melt flow index of 30 grams/10 minutes to 75 grams/10 minutes when measured according to ASTM D1238-04 at 300° C. and 1.2 kilograms.

14. The method of claim 13, wherein the poly(ester-carbonate) is a poly(aliphatic ester)-carbonate derived from a linear C6-20 aliphatic dicarboxylic acid.

15. The method of claim 14, wherein the poly(aliphatic ester)-carbonate comprises bisphenol A sebacate ester units and bisphenol A carbonate units and has a weight average molecular weight of 10,000 to 40,000 as determined by GPC using polycarbonate standards.

16. The method of claim 6, wherein the thermoplastic material comprises a poly(siloxane-carbonate) copolymer having a melt flow index of 30 grams/10 minutes to 75 grams/10 minutes when measured according to ASTM D1238-04 at 300° C. and 1.2 kilograms.

17. The method of claim 16, wherein the poly(siloxane-carbonate) copolymer comprises 50 to 99 weight percent of carbonate units and 1 to 50 weight percent siloxane units and has a weight average molecular weight of 15,000 to 35,000 as determined by GPC using polycarbonate standards.

18. The method of any of claims 1 to 17 claim 1, wherein the thermoplastic composition has a melt flow index of 33 grams/10 minutes to 60 grams/10 minutes when measured according to ASTM D1238-04 at either 230° C. and 3.8 kilograms or at 300° C. and 1.2 kilograms.

19. An article made a material extrusion additive manufacturing technique using
at least one polycarbonate homopolymer, polycarbonate copolymer, polyester, or a combination thereof, having a melt flow index of 30 grams/10 minutes to 75 grams/10 minutes when measured according to ASTM D1238-04 at either 230° C. and 3.8 kilograms or at 300° C. and 1.2 kilograms, said article a shear strength of 16 MPa to 25 MPa.

20. The article of claim 19 wherein the article comprises at least 20 layers and is extruded at a temperature of 200° C. to 300° C.
